(19) United States
(12) Patent Application Publication
(10) Pub. No.: US 2006/0168033 A1
(43) Pub. Date: Jul. 27, 2006

(54) Spam white list

(75) Inventors: Yigang Cai, Naperville, IL (US); Shehryar S. Qutub, Hoffman Estates, IL (US); Alok Sharma, Lisle, IL (US)

Correspondence Address: WERNER ULRICH, 434 MAPLE STREET, GLEN ELLYN, IL, 60137-3826, US

(73) Assignee: Lucent Technologies, Inc.

(21) Appl. No.: 11/018,436

(22) Filed: Dec. 21, 2004

(51) Int. Cl. G06F 15/16

(52) U.S. Cl. 709/206; 709/203

(57) ABSTRACT

A spam filtering system is simplified if it has a black list and white list of source terminals for each destination terminal since all traffic from a white list is automatically completed and all traffic from a black list is automatically blocked. In order to avoid traffic problems from problem sources on a white list, traffic measurements are made of traffic from white list sources. If the traffic level and other thresholds exceed a pre-provisioned parameter, then steps are taken to decrease the allowable traffic rate and other measurements from that source and to examine messages from that source to determine whether they include spam messages. Advantageously, the virtues of a white list (simple examination of messages to determine whether they can be passed) can be retained while avoiding the problems of excessive spam traffic from false white list sources.

### RELATED APPLICATION(S)

This application is related to the applications of:

Yigang Cai, Shehryar S. Qutub, and Alok Sharma entitled “Storing Anti-Spam Black Lists”;

Yigang Cai, Shehryar S. Qutub, and Alok Sharma entitled “Anti-Spam Server”;

Yigang Cai, Shehryar S. Qutub, and Alok Sharma entitled “Detection Of Unwanted Messages (Spam)”;

Yigang Cai, Shehryar S. Qutub, and Alok Sharma entitled “Unwanted Message (Spam) Detection Based On Message Content”;

Yigang Cai, Shehryar S. Qutub, Gyan Shanker, and Alok Sharma entitled “Spam Checking For Internetwork Messages”; and

Yigang Cai, Shehryar S. Qutub, and Alok Sharma entitled “Anti-Spam Service”;

which applications are assigned to the assignee of the present application and are being filed on an even date herewith.

### TECHNICAL FIELD

This invention relates to arrangements for adjusting an accept list (white list) in an anti-spam filtering system.

### BACKGROUND OF THE INVENTION

With the advent of the Internet, it has become easy to send messages to a large number of destinations at little or no cost to the sender. The same is true of short message service (SMS). These messages include unsolicited and unwanted messages (spam) which are a nuisance to the receiver of the message who has to clear the message and determine whether it is of any importance. Further, it is a nuisance to the carrier of the telecommunications network used for transmitting the message, not only because it presents a customer relations problem with respect to irate customers who are flooded with spam, but also because these messages, for which there is usually little or no revenue, use network resources. An illustration of the seriousness of this problem is given by the following two statistics. In China in 2003, two trillion short message service (SMS) messages were sent over the Chinese telecommunications network; of these messages an estimated three quarters were spam messages. The second statistics is that in the United States an estimated 85-90% of e-mail messages are spam.

A number of arrangements have been proposed and many implemented for cutting down on the number of delivered spam messages. Various arrangements have been proposed for analyzing messages prior to delivering them. According to one arrangement, if the calling party is not one of a pre-selected group (“White List”) specified by the called party, the message is blocked or subjected to further anti-spam checks. Spam messages can also be intercepted by permitting a called party to specify that no messages destined for more than N destinations are to be delivered.

A called party can refuse to publicize his/her telephone or mobile number or e-mail address. In addition to the obvious disadvantages of not allowing callers to look up the telephone number or e-mail address of the called party, such arrangements are likely to be ineffective. An unlisted e-mail address can be detected by a sophisticated hacker from IP network, for example, by monitoring message headers at a router. An unlisted called number simply invites the caller to send messages to all 10,000 telephone numbers of an office code; as mentioned above, this is very easy with present arrangements for sending messages to a plurality of destinations.

Many spam filtering systems include a “white list” of sources from which messages will automatically be accepted and a “black list” of sources from which messages will be automatically rejected. These lists make it possible to determine for a large fraction of the messages whether the messages are to be blocked or passed.

A problem of the prior art is that the black list/white list approach is insufficiently flexible for meeting the needs of preventing ingenious Spammers from penetrating the anti-spam filter.

### SUMMARY OF THE INVENTION

Applicants have carefully studied the black list/white list approach to filtering spam and preventing spam messages from being completed to the destination and have recognized that if a determined Spammer can get access to a white list source, the protections of the anti-spam arrangement are overcome. This is bad enough but under these circumstances a particularly annoying Spammer may send large numbers of spam messages, thus flooding the destination telecommunications station or the e-mail bin of such a destination.

The concept behind a white list is to allow all messages from trusted sources, i.e., those on the white list, to pass through without additional checks. Since the number of messages traversing a network at any one given time is likely to be very large, the use of white lists helps to reduce the number of messages that are examined in detail. That reduces the possibility of network congestion and consequent delays in SMS message delivery. However, the use of a fixed or static white list of trusted sources may not be sufficient to help manage traffic surges or avoid delivery of a large number of spam messages. For example, the total number of messages in a given period (e.g., hourly or daily) from a specific foreign network that is on the white list may exceed a given threshold but because the source is on a fixed white list, no alarms may be raised. Similarly, spam messages from a white listed source may go unchecked, a situation that may take on alarming proportions if the trusted source has been compromised.

The white list problem is alleviated in accordance with Applicants' invention wherein traffic statistics are maintained for each active white list source and if the number of messages exceeds parameters specified by the telecommunications carrier of the service or the destination customer, the white list traffic from that source is throttled and eventually blocked. Advantageously, such an arrangement will not interfere with the legitimate traffic from white list sources. Advantageously, traffic from a white list source which exceeds the parameters allowed for that source can be throttled.

In accordance with one specific embodiment of Applicants' invention, the dynamic white list arrangement is applied for use with short message service. A short message service, service center or a more general anti-spam (ASA) system, retains white list destination data and traffic data for individual white list sources. A white list is maintained for each destination that subscribes to anti-spam service. For each white list source, traffic data is maintained and as each new message is received the traffic data is updated and checked against traffic parameters for that source to see if throttling is appropriate. Throttling is accomplished by changing the parameters which limit the number of messages acceptable per unit time.

For some entries on the white list, the status can change according to time or day of the week In a facility which is sometimes unattended, it may be desirable to clear the white list status during unattended periods so that spammers who gain unauthorized access to a building cannot send spam during the unattended hours.

For a white list source which has been temporarily denied white list status because of excess traffic, as traffic decreases the white list status can be restored.

For some sources, it can be desirable to dynamically adjust the status from white, to gray (equivalent to no list status) to black for light, medium or heavy traffic or other measurement such as the frequency of spam messages from the source.

Messages from white list sources can be sampled to ensure that the frequency of spam messages from these sources is below a threshold.

### BRIEF DESCRIPTION OF THE DRAWING(S)

FIG. 1 is a block diagram illustrating the system for controlling spam using a database in a short message service center (SMSC);

FIG. 2 is a block diagram illustrating a system for reducing spam using an anti-spam Application (ASA) general database for performing anti-spam functions for a variety of telecommunications services; and

FIG. 3 is a memory layout diagram illustrating the use of white lists and traffic tables to allow excess white list messages to be blocked.

### DETAILED DESCRIPTION

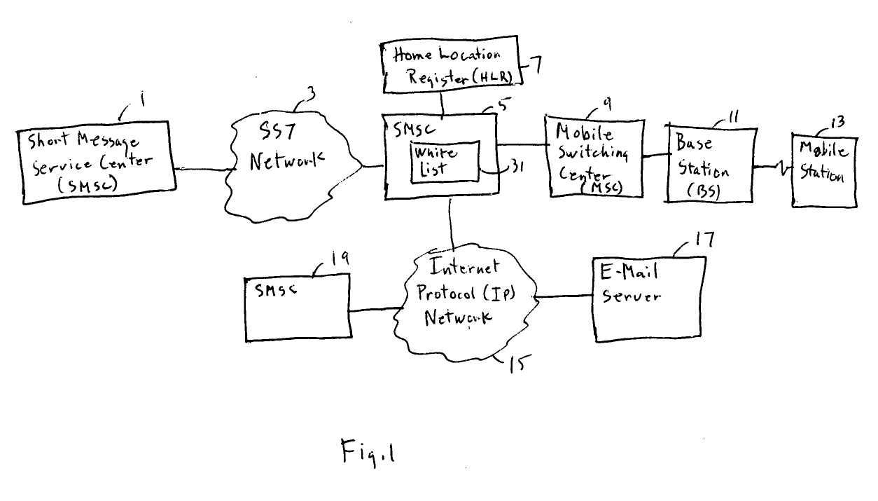

FIG. 1 illustrates a wireless network with an anti-spam application resident on a short message service center 1. The short message service center which is connected to a source of a short message service message (not shown) is connected via an SS7 network 3 to a second SMSC 5. The second SMSC contains memory 31 for implementing the blockage of excessive white list messages. SMSC 5 communicates with home location register (HLR) 7 to determine the destination of the short message. SMSC 5 is connected to a mobile switching center 9 controlling a base station 11 for communicating with a destination mobile telecommunications unit 13. SMSC 5 is also connected via the Internet Protocol (IP) network 15 to another SMSC 19 for communication with other mobile stations or to an e-mail server 17 for collecting e-mail from the source.

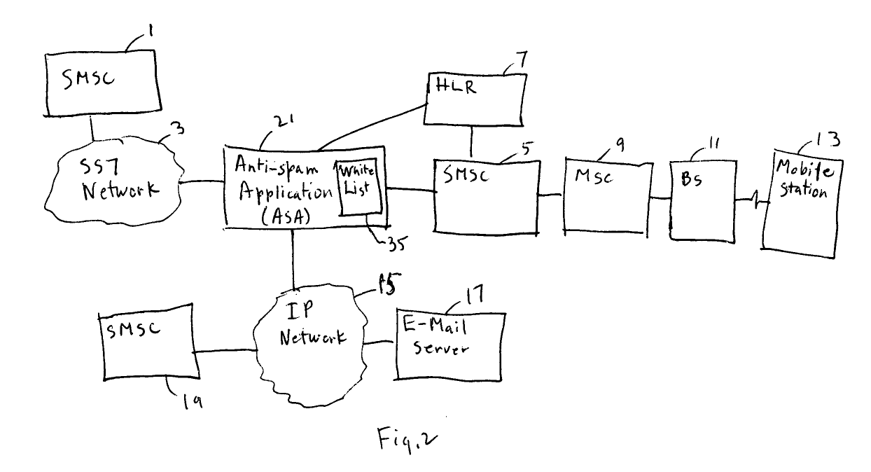

The system of FIG. 2 is very similar to that of FIG. 1 except that the white list 35 is stored in an anti-spam application (ASA) 21.

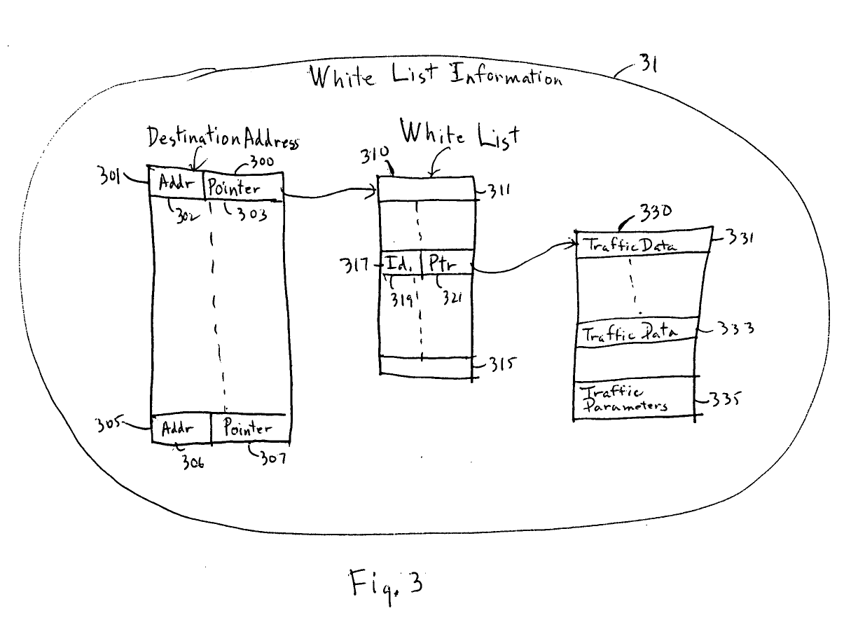

FIG. 3 illustrates a memory layout of the white list information. Block 300 is a head table of destination addresses with associated pointers pointing to white lists associated with each destination address. For example, block 301 contains a destination address 302 and a pointer 303 associated with that destination address. Similarly, block 305 records a destination address 306 and a pointer 307 for the white list of that destination address. Block 310 is a white list of one of the destination addresses. For each entry on the list, there is an identification of the white list source and a pointer to a traffic block for regulating messages from that source. White list 310 includes entries 311, 317, . . . , 315. Block 317 contains an identity 319 of a source and a pointer 321 to a traffic block, in this case traffic block 330. Traffic block 330 contains traffic data 331 . . . 333 and traffic parameters 335. Included in the traffic parameters are limits which, if exceeded in a specified interval, are warnings that spam may be generated by the white list source. In a case where a particular white list entry is listed for a plurality of destinations, as would be the case for messages from a foreign network, the pointers in the plurality of destinations all point to the same traffic data block.

For each source traffic data block on the white list, traffic volumes, message size, frequency of messages sent from a particular source, and message content is examined during a specific time interval. The start time and length of each interval may be pre-provisioned or can be dependent upon the occurrence of traffic conditions (traffic volume, number of spam messages, etc.) in a prior time period. The spam messages can be detected because if there is reason to consider throttling, the messages may be examined for content in order to determine whether they are spam messages.

Traffic counts can also be maintained for a specific source. This is especially useful where the source is a foreign network whose traffic is not normally checked for spam messages. However, if the traffic rate exceeds a predetermined threshold, it is desirable to start making spam checks, and, if necessary, throttle block traffic from that source.

Generally, the system may use one or several threshold criteria to change the status of a trusted source. These thresholds may include the total number of messages from a source during the period; the total frequency of messages, i.e., the number of adjacent messages from a given source in that period; the number of identical messages from a given source during that period; and the number of messages from the source that are designated as spam in that period.

The severity of threshold violations, either singly or in combination, determines the trustworthiness of a white listed source until at least the next examination period. New levels of trustworthiness may be used to: throttle from an errant source; update the charging criteria for traffic from the source (e.g., increase the charge rate per packet according to predefined criteria); close connections with a data source if the violations are grievous; move the source to another list which is examined more frequency and under more stringent conditions, i.e., move the source to a watch list if the violations are deemed to be minor; or reverse all or some of the above if no thresholds have been violated for a predefined period of time.

The trustworthiness of a white listed source can be dynamically changed based on traffic measurements and anti-spam thresholds. For example, the trustworthiness level of a white listed source can be assigned as 1 to 10 whereas 10 is most trusted, 1 is least trusted or is, in fact, reclassified into the black list. The dynamic white list combines white, gray, and black lists entries in one list for the short message service screening. For less trusted sources, anti-spam checks are more frequent.

The trustworthiness level of a white listed source will also be changed based on the threshold with different levels. For example, if the total number of the same message from one source in ten minutes exceeds 100, 1,000, or 100,000, will impact differently on the trustworthiness level of a white list source. If the trustworthiness level decreases to a certain level, the SMSC or ASA can send a network alarm to the network management agent to get some control of this source. If the trustworthiness level decreases to an unallowable level, such a 1, the SMSC or ASA will alarm the network management agent to adjust the bandwidth allowed for this network source, modify the charging regulation and billing rate against the accounts, or totally block the source. The network alarm conditions and severity levels are pre-provisioned at the SMSC or ASA.

Within the dynamic white list, beside the trustworthiness level, a dynamic measurement interval is also set for each source identity. When the trustworthiness level decreases, the time of measurement interval is shortened. The SMSC or ASA will more closely monitor this source. With a dynamic white list furnished at the SMSC or ASA, SMS traffic can be better managed and the quality of service of the network improved.

The same arrangement can be used for many different types of telecommunications traffic representing automated tele-market calls, computer generated data or voice calls. It can also be used for automatically blocking repeated calls to a telephone or mobile station.

For some entries on the white list, the status can change according to time or day of the week In a facility which is sometimes unattended, it may be desirable to clear the white list status during unattended periods so that spammers who gain unauthorized access to a building cannot send spam during the unattended hours.

For a white list source which has been temporarily denied white list status because of excess traffic, as traffic decreases the white list status can be restored.

For some sources, it can be desirable to dynamically adjust the status from white, to gray (equivalent to no list status) to black for light, medium or heavy traffic or other measurement such as the frequency of spam messages from the source.

Messages from white list sources can be sampled to ensure that the frequency of spam messages from these sources is below a threshold.

The above description is of one preferred embodiment of Applicants' invention. Other embodiments will be apparent to those of ordinary skill in the alt without departing from the scope of the invention. The invention is limited only by the attached claims.

We claim:

1. In an unwanted message (spam) control system having a white list of sources whose traffic can be completed to a destination terminal of said white list, a method of limiting spam messages, comprising the steps of:
maintaining traffic counts for messages from a source on said white list to said destination;
if said traffic counts indicate that traffic from said source to said destination exceeds a pre-provisioned value, changing treatment of messages or calls from said source to said destination so that subsequent traffic from said source to said destination is not automatically completed.

2. The method of claim 1 wherein the step of changing treatment comprises the step of performing anti-spam checks on at least some of the messages from said source.

3. The method of claim 1 wherein said source is a foreign network.

4. The method of claim 1 wherein at least some of said traffic counts are maintained for source/destination pairs.

5. The method of claim 4 wherein repeated calls or messages from a specific source to a specific destination are blocked.

6. The method of claim 1 wherein following a period of traffic substantially less than said pre-provisioned value, treatment of said messages or calls is restored to treatment provided before traffic exceeded said pre-provisioned value.

7. The method of claim 1 wherein a message from a service bureau can be used to alter said pre-provisioned value.

8. In an unwanted message (spam) control system having a white list of sources whose traffic can be completed to a destination terminal of said white list, apparatus for limiting spam messages, comprising:
means for maintaining traffic counts for messages from a source on said white list to said destination;
if said traffic counts indicate that traffic from said source to said destination exceeds a pre-provisioned value, means for changing treatment of messages or calls from said source to said destination so that subsequent traffic from said source to said destination is not automatically completed.

9. The apparatus of claim 8 wherein the means for changing treatment comprises means for performing anti-spam checks on at least some of the messages from said source.

10. The apparatus of claim 8 wherein said source is a foreign network.

11. The apparatus of claim 8 wherein at least some of said traffic counts are maintained for source/destination pairs.

12. The apparatus of claim 11 wherein repeated calls or messages from a specific source to a specific destination are blocked.

13. The apparatus of claim 8 wherein following a period of traffic substantially less than said pre-provisioned value, wherein said means for changing treatment of said messages or calls restores treatment to treatment provided before traffic exceeded said pre-provisioned value.

14. The apparatus of claim 8 comprising means, responsive to receipt of a message from a service bureau for altering said pre-provisioned value.
